(19) United States
(12) Patent Application Publication
(10) Pub. No.: US 2018/0033496 A1
(43) Pub. Date: Feb. 1, 2018

(54) SYSTEMS, METHODS, AND DEVICES FOR INERTIAL ELECTROSTATIC CONFINEMENT

(71) Applicant: University of Maryland, College Park, College Park, MD (US)

(72) Inventors: Raymond J. SEDWICK, University Park, MD (US); Andrew CHAP, Chevy Chase, MD (US)

(21) Appl. No.: 15/659,962

(22) Filed: Jul. 26, 2017

Related U.S. Application Data
(60) Provisional application No. 62/367,410, filed on Jul. 27, 2016.

(51) Int. Cl. G21B 1/03; B64G 1/40

(52) U.S. Cl. CPC G21B 1/03; B64G 1/408; B64G 1/405

(57) ABSTRACT

A continuous electrode (CE) inertial electrostatic confinement (IEC) device has particle paths radially extending from a central core region. Each particle path has a corresponding particle path aligned on an opposite side of the central core region. Sidewalls bounding the particle paths provide continuous surfaces radially extending from a cathode region proximal to the central core region to an anode region remote from the central core region. Electrodes are coupled to the sidewalls to provide an electric field that varies along each particle path from the cathode region to the anode region. The CE-IEC device can be used for particle fusion by directing ions along the particle paths to the central core region, for example, to generate power or to propel a spacecraft.

### CROSS-REFERENCE TO RELATED APPLICATIONS

The present application claims the benefit of U.S. Provisional Application No. 62/367,410, filed Jul. 27, 2016, which is hereby incorporated by reference herein in its entirety.

### STATEMENT REGARDING FEDERALLY SPONSORED RESEARCH

This invention was made with government support under NNX13AL44H awarded by the National Aeronautics and Space Administration (NASA). The government has certain rights in the invention.

### FIELD

The present disclosure generally relates to nuclear fusion, and, more particularly, to fusion by inertial electrostatic confinement using a device with continuous walls.

### SUMMARY

In embodiments, a continuous electrode (CE) inertial electrostatic confinement (IEC) device employs sidewalls with substantially continuous surfaces radially extending from a central core to define radial particle paths. Electrodes coupled to the sidewalls provide an electric field that varies along each particle path to accelerate ions within the particle paths toward the core. Interaction of the ions within the core can result in nuclear fusion, which may be used for electricity generation or for spacecraft propulsion. The CE-IEC device can include one or more features designed to decrease distances between ions, for example, by compacting ion bunches as they travel along the particle paths and/or neutralizing space charge of ion bunches within the core using a population of electrons captured therein.

In one or more embodiments, a device comprises a central core region, particle paths, sidewalls, electrodes, and a control module. Each particle path can radially extend from the central core region and can have a corresponding particle path aligned therewith on an opposite side of the central core region. The sidewalls can extend in a radial direction. Each particle path can be bounded by a corresponding set of the sidewalls. The electrodes can be coupled to the sidewalls so as to provide an electric field that varies along each particle path from a cathode region proximal to the central core region to an anode region remote from the central core region. The control module can control the electrodes to provide the electric field. Each sidewall can provide a continuous surface radially extending from the cathode region to the anode region.

In one or more embodiments, a fusion method comprises directing ion bunches along particle paths that radially extend from a central core region. Each particle path can be bounded by a corresponding set of radially extending sidewalls and can have a corresponding particle path aligned therewith on an opposite side of the central core region. Each sidewall can provide a continuous surface radially extending from a cathode region proximal to the central core region to an anode region remote from the central core region. The method can further comprise generating an electric field that varies along each particle path from the cathode region to the anode region such that the ion bunches are accelerated toward the central core region, and fusing ions from the ion bunches within the central core region. The method can also comprise allowing fusion products to travel from the central core region to beyond the anode region via the particle paths.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated or otherwise simplified to assist in the illustration and description of underlying features. Throughout the figures, like reference numerals denote like elements.

FIG. 1A is an isometric view of a CE-IEC device employing a square configuration, according to one or more embodiments of the disclosed subject matter.

FIG. 1B is a view of FIG. 1A along one of the particle paths, according to one or more embodiments of the disclosed subject matter.

FIG. 1C is a cross-sectional view of a CE-IEC device, according to one or more embodiments of the disclosed subject matter.

FIG. 1D is a graph of an exemplary electrical potential profile along one of the particle paths of FIG. 1C, according to one or more embodiments of the disclosed subject matter.

FIG. 1E-1G are cross-sectional views of a CE-IEC device with ion bunches traveling and interacting to produce fusion products, according to one or more embodiments of the disclosed subject matter.

FIG. 2A is a cross-sectional view of a CE-IEC device employing sidewalls with variable resistivity, according to one or more embodiments of the disclosed subject matter.

FIG. 2B is a cross-sectional view of a CE-IEC device employing sidewalls with segments having different electric potentials applied thereto, according to one or more embodiments of the disclosed subject matter.

FIG. 3A is a cross-sectional view showing construction of a sidewall in a CE-IEC device that has a permanent magnet therein, according to one or more embodiments of the disclosed subject matter.

FIG. 3B is a cross-sectional view showing construction of a sidewall in a CE-IEC device that is formed of a permanent magnet, according to one or more embodiments of the disclosed subject matter.

FIG. 3C shows exemplary magnetic field lines for a CE-IEC device employing the sidewall construction of either FIG. 3A or FIG. 3B.

FIG. 4A is a cross-sectional view showing construction of a sidewall in a CE-IEC device that has multiple permanent magnets therein, according to one or more embodiments of the disclosed subject matter.

FIG. 4B is a cross-sectional view showing construction of a sidewall in a CE-IEC device that is formed of multiple permanent magnets, according to one or more embodiments of the disclosed subject matter.

FIG. 4C shows exemplary magnetic field lines for a CE-IEC device employing the sidewall construction of either FIG. 4A or FIG. 4B.

FIG. 5 is a magnified cross-sectional view of a CE-IEC device employing protective standoffs, according to one or more embodiments of the disclosed subject matter.

FIG. 6 is an isometric view of a CE-IEC device employing a square configuration with conduits at vertices between adjacent sidewalls, according to one or more embodiments of the disclosed subject matter.

FIG. 7A is a cross-sectional view showing an exemplary configuration for electrical coupling for a variable resistivity sidewall via a conduit, according to one or more embodiments of the disclosed subject matter.

FIG. 7B is a cross-sectional view showing an exemplary configuration for electrical coupling for a variable resistivity sidewall via a conduit with a permanent magnet, according to one or more embodiments of the disclosed subject matter.

FIG. 7C is a cross-sectional view showing an exemplary configuration for electrical coupling for a segment of a sidewall via a conduit, according to one or more embodiments of the disclosed subject matter.

FIG. 7D is a cross-sectional view showing an exemplary configuration for electrical coupling for multiple segments of sidewalls via a conduit, according to one or more embodiments of the disclosed subject matter.

FIG. 8 is a cross-sectional view showing an exemplary configuration for ion supply to the particle pathways via a conduit, according to one or more embodiments of the disclosed subject matter.

FIG. 9 is a cross-sectional view showing an exemplary configuration of sensors and signal communication via a conduit, according to one or more embodiments of the disclosed subject matter.

FIG. 10 is a simplified schematic of a CE-IEC system for particle fusion, according to one or more embodiments of the disclosed subject matter.

FIGS. 11A-11C show stages in converting fusion products to electricity using standing wave direct energy conversion (SW-DEC), according to one or more embodiments of the disclosed subject matter.

FIG. 11D is a simplified schematic of an RLC circuit employing SW-DEC for direct energy usage, according to one or more embodiments of the disclosed subject matter.

FIG. 11E is a cross-sectional view of a CE-IEC device with SW-DEC rings in an outer power conversion region, according to one or more embodiments of the disclosed subject matter.

FIG. 12A is an isometric view of a CE-IEC device employing a special irregular truncated icosahedron (SITI) configuration, according to one or more embodiments of the disclosed subject matter.

FIG. 12B is a cutaway view of FIG. 12A showing exemplary magnetic field lines, magnets embedded in walls, and an exemplary electric potential profile.

### DETAILED DESCRIPTION

In embodiments, an inertial electrostatic confinement (IEC) device has radially extending sidewalls that define radial particle paths emanating from a central core. Electrodes can be coupled to these sidewalls in order to provide an electric field that varies along the particle paths, for example, from a radially-outer anode region (remote from the central core) to a radially-inner cathode region (proximal to the central core). As such, embodiments employing continuous sidewalls with coupled electrodes are referred to herein as continuous electrode (CE). Although the sidewalls are referred to as continuous, this does not require that the sidewalls be monolithic or isotropic. Rather, the continuous sidewalls provide a substantially continuous surface from the anode region to the cathode region and can have different properties at different radial or azimuthal locations (e.g., formed of different material segments at different radial locations and/or having a resistivity that varies radially).

The electric field can accelerate ions toward the core, where the ions interact to yield nuclear fusion. Non-reacting ions can pass through the core to an opposite (aligned) particle path, where the electric field therein slows the ions to reverse direction and accelerate back toward the core for further interactions. Unlike conventional IEC devices that employ multiple independent grids of different radii centered on the core to provide an electric field, embodiments of the present disclosure employing continuous sidewalls allow the electric potential to be imposed continuously over the particle path and/or to dynamically adjust the electric potential as ions travel within the particle paths (e.g., to compact traveling ion bunches prior to introduction to the core). The continuous sidewalls can also provide a very high grid transparency (i.e., greater than 70%, for example, ˜85%) as seen from the core without otherwise sacrificing structural rigidity.

The sidewalls also provide real estate for conduits from external to the device toward the central core, for example, to provide electrical connections for power or signal transmission, to provide a magnetic field using permanent magnets, and/or to feed ions into the particle paths. While the sidewalls provide an additional surface area that ions could strike (representing a loss to the system) that multiple independent grids would otherwise lack, such ions would be on non-radial trajectories and thus would likely not contribute to nuclear fusion anyway.

Since the ions interact in the core, fusion products are only generated in the core and leave along predominantly radial paths, e.g., along the radially extending particle paths. In general, the IEC device should be as transparent as possible to these energetic particles. In other words, the construction of the IEC device (e.g., sidewalls) should subtend as little solid angle (as seen by the core) as possible. To that end, any radially outer structure that falls within the “shadow” of radially inner structures, as viewed from the device center, will not diminish the transparency of the system. Thus, in embodiments, structures are arranged to fall within this “shadow” of the innermost structure, which is designed to subtend as little solid angle as possible. In other words, the sidewalls could be considered a radially outward extrusion of the innermost edge (adjacent to the core).

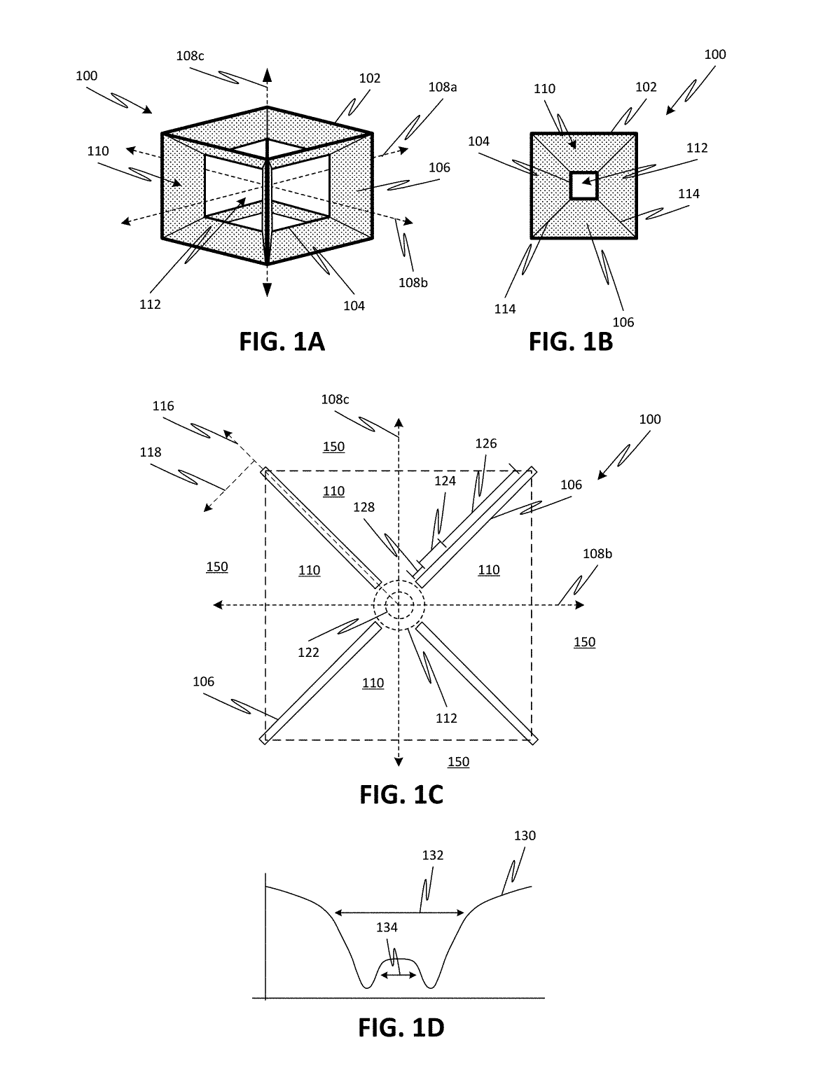

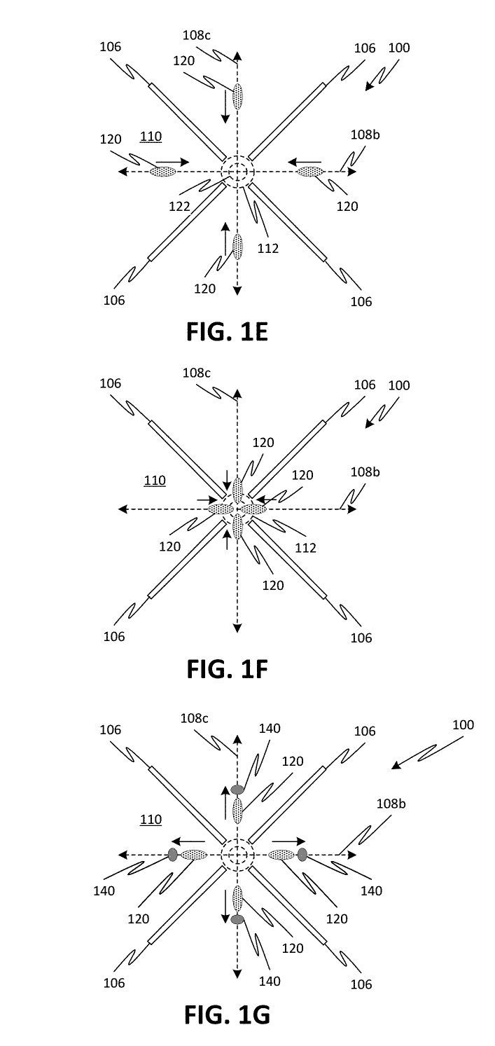

FIG. 1A shows an isometric view of a simplified CE-IEC device 100. FIG. 1B shows a side view of the CE-IEC device 100. The simplified CE-IEC device 100 employs a cubic configuration, where the innermost edge 104 formed by radially extending sidewalls 106 is a cube surrounding a central core region 112. The outermost edge 102 formed by the sidewalls 106 can also be a cube. The sidewalls 106 can be continuous between the innermost edge 104 and outermost edge 102 and define three radial particle paths 108a-108c. Each sidewall 106 can abut an adjacent sidewall 106 along a radially extending vertex 114. Each particle path is bounded on four sides (defining a square face perpendicular to the radial direction) by the sidewalls 106, such that each half of the particle path outside the core region 112 takes the form of a truncated pyramid. Note that the particle paths 108a-108c can be considered a single path that extends through the central core region 112, or as separate but aligned paths on opposite sides of the central core region.

Referring to FIGS. 1C and 1E-1G, cross-sectional views of CE-IEC device 100 are shown in order to describe various features thereof. In particular, the CE-IEC device 100 can be considered to have four main regions along the radial direction 116: (1) an innermost core region 122, (2) an outer core region 112 surrounding the innermost core region 122, (3) a focusing region 110 between sidewalls 106 and along particle paths 108a-108c, and (4) a power conversion region 150 beyond the sidewalls 106.

The focusing region 110 is where the CE structure (i.e., sidewalls 106) is disposed. The open channels between facing sidewalls 106 in the focusing region 110 form the particle paths 108a-108c, along which ion bunches recirculate as they pass into and out of the core. A radially outer region of the sidewalls 106 can be biased at a relatively higher voltage to form anode region 126, while a radially inner region of the sidewalls 106 can be biased at a relatively lower voltage to form cathode region 124. The resulting electric field in the focusing region 110 causes the ions to accelerate toward the core 112. Since the potential profile is generated solely in the focusing region 110, the ions will drift through the core at a constant speed.

Over time, the traveling ions self-assemble into bunches 120 due to two-stream instability. Moreover, due to cross-talk, the bunches 120 synchronize between different particle paths 108a-108c, as shown in FIG. 1E, such that the bunches 120 arrive at the inner core region 122 at substantially the same time, as shown in FIG. 1F. Alternatively or additionally, ions could be introduced into the particle paths 108a-108c in a pulsed manner (i.e., at different times), thereby forming preliminary ion bunches. The formation of bunches and the synchronization results in a beneficial situation since the ion bunches 120 only cross in the inner core 122.

Low angle scattering between counter-streaming ions, which would normally result in the rapid global thermalization of the ion population, is suppressed by local thermalization within each of the bunches 120 near the anode region 126. Moreover, the low-angle collisions among opposing bunches within the core merely reshuffle the specific radial trajectories among the particle paths 108a-108c that the individual ions will follow to exit the inner core 122. Upon refocusing (in focusing region 110), the velocity distribution in the azimuthal direction 118 within each bunch 120 should be indistinguishable from the start of the previous pass, cancelling any azimuthal momentum growth. Low angle scatters among non-opposing ion bunches can introduce both azimuthal and radial (energy) scattering. However, on average these scattering events will both up-scatter and down-scatter the ions equally. Upon refocusing (in focusing region 110), the net ion energy within each bunch 120 due to low angle ion-ion collisions should remain the same.

High angle scatters are confined to the core where the resulting ion trajectories will still be approximately radial. In other words, if the scattering angle of the ion does not otherwise cause it to collide with the inner edge of a sidewall 106, the ion should simply end up in a different channel (proceeding along a different particle path 108a-108c) rather than being lost. Upon refocusing (in focusing region 110), the ion will be merged into the traveling ion bunch 120. Thus, the electric potential within the particle pathways can help keep scattered ions from being lost.

To increase the density of ion bunches as they pass into the core 112, where the bulk coulomb repulsion of the ions would tend to push them apart, a population of electrons is confined to the core of the device in order to neutralize the space charge of the ions. For example, an electron population can be generated within the core by completely ionizing the fusion fuel (e.g., boron), which may be only singly ionized initially prior to injection. For example, any remaining electrons of the fusion fuel can be stripped, either through collisions with other ions passing through the core or as a result of a nuclear fusion event. Alternatively or additionally, electrons can be injected directly into the core, for example, to replenish those that might be lost over time and that would otherwise not be replenished by further ionizing the fusion fuel.

To help confine the electrons to the core, the sidewalls 106 may further provide another anode region 128 adjacent to the core (i.e., radially between the cathode region 124 and the outer core 112). The resulting electric field can create a reversed potential well for electrons that keeps them from escaping the core along particle pathways. For example, FIG. 1D shows a graph of an exemplary electric potential 130 along one of the particle paths 108a-108c. Region 132 represents a confinement field for the ions (i.e., between the sidewalls 106 along the particle pathways) while region 134 represents the confinement field for the electrons (i.e., within the core). Alternatively or additionally, a magnetic field may be provided to keep electrons from escaping along the particle paths 108a-108c, as described in further detail elsewhere herein.

The ions thus travel from the anode region 126 to the cathode region 124 (see FIG. 1E) and on to the outer core region 112 (see FIG. 1F), which is a transition region where the ions interact with the confined electron population. As the ions pass into the outer core 112, the electron population responds by being attracted to the ions, thereby neutralizing their space charge and allowing the ions to further compress along their radial trajectories as they move toward the inner core region 122. Within the inner core region 122, the ions traveling in crossing or opposite directions along the particle paths collide, exchanging energy and momentum and in some cases undergoing nuclear fusion. In general, the central core region may be substantially empty except for the electrons confined therein, ions traveling therethrough between the particle paths, and products resulting from interaction of the traveling ions.

Unreacted ions 120 and/or fusion products 140 travel along substantially radial paths out of the inner core region 122 to the outer core region 112, where they leave behind the confined electrons before passing back into the focusing region 110 (see FIG. 1G). The outer edge of the focusing region 110 (i.e., outermost edge of the anode region 126) represents the maximum radial extent to which the ion bunches 120 are allowed to reach, with only fusion products 140 being energetic enough to proceed into power conversion region 150.

The fusion products 140 can thus continue through focusing region 110 and escape to power conversion region 150 beyond sidewalls 106, where the fusion products 140 can be converted to electricity or otherwise used to generate work (e.g., to propel a spacecraft). The fusion products 140 can enter the power conversion region 150 with a nearly isotropic angular distribution and can arrive in pulses a few nanoseconds long separated by several microseconds. The pulsed output of the fusion products 140 can be converted to electricity using a direct conversion process, for example, Traveling Wave Direct Energy Conversion (TW-DEC) or Standing Wave Direct Energy Conversion (SW-DEC), as described in further detail elsewhere herein.

When the ions leave the outer core 112, their self-charge will still tend to cause the bunches of ions to expand. Thus, as they travel along the particle paths 108a-108c in the focusing region 110, the ions 120 can also be continuously refocused and compressed (due to the electric potential provided by the sidewalls 106 and/or magnetic fields from permanent magnets of the sidewalls 106) to combat this natural spreading due to space charge and/or low angle collisions.

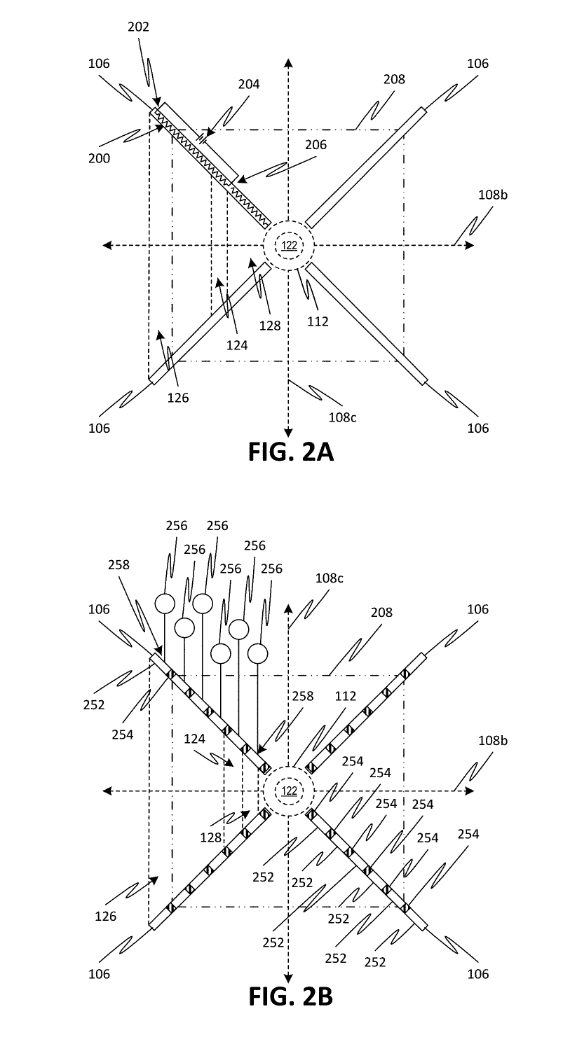

As noted above, embodiments of the CE-IEC device can provide a potential that varies continuously in the focusing region 110. FIG. 2A illustrates a configuration where the continuous sidewalls 106 can provide such an electric potential. In particular, the sidewall 106 can be formed of a material 200 that has a resistivity that varies along the radial direction 116. Portions of the sidewall 106 at different radii can be connected to a potential difference. For example, a voltage source 204 can be connected between a radially outer portion 202 (e.g., an anode region 126) and a radially inner portion 206 (e.g., a cathode region 124). For example, the outer portion 202 can be set to ground while the inner portion 206 can be set to −50 kV.

At each radial location on the sidewall, the resistivity normal to the radial direction can be very low, such that locations on the same sidewall at the same radial distance from the core can be held at substantially the same potential. In other words, portions of the sidewall 106 at the same radii would act as an isopotential conductor. Moreover, portions of different sidewalls 106 (i.e., falling along isopotential line 208 in FIG. 2A) can also be at substantially the same potential. Note that the isopotential line 208 connects locations on the sidewalls that are at the same potential, not between the sidewalls in the open regions of the particle paths where the potential would necessarily be different.

The variable resistivity material 200 may be accomplished, for example, by engineering a composite material having strips of different material layers at different radii extending in a direction perpendicular to the radial direction 116. Adjacent strips are electrically coupled to each other along contacting faces perpendicular to the radial direction 116 to provide the radially varying resistivity, while otherwise acting as isopotential conductors in a direction perpendicular to the radial direction. The composition of the material 200 can be customized to achieve any desired radial potential profile. For example, the potential profile can monotonically decrease from the anode region to the cathode region, or can be a complex profile that does not necessarily monotonically decrease). For example, the sidewall material can be formed via 3-D printing.

Alternatively or additionally, a customized potential profile can be achieved using a segmented continuous sidewall structure, as illustrated in FIG. 2B. Each sidewall 106 (or a selection of sidewalls) can include a plurality of segments 252 at different radii from the core 122. Each segment 252 can be separated from an adjacent segment 252 in the radial direction by an insulating spacer 254, such that each segment 252 is electrically isolated from the other segments 252 of the sidewall 106. The segments 252 can thus be independently controlled (for example, by providing independent voltage sources 256 connected to the segments at 258) to provide a custom electric potential along the particle paths 108a-108c. Each segment 252 can be composed of the same material or of different materials, and can act as isopotential conductors in a direction perpendicular to the radial direction.

Although shown in FIG. 2B as being the same size, the segments 252 can also be of different sizes. For example, one or more intermediate segments 252 between anode region 126 and cathode region 124 can be made smaller than the other segments 252. These smaller segments 252 can be used to dynamically vary the potential as ion bunches pass, for example, to compact the ion bunches by providing a perturbation that slows ions at the front of the bunch and/or accelerates ions at the rear of the bunch. In addition, the number of spacers 254 and/or segments 252 illustrated in FIG. 2B are exemplary only, and other numbers are also possible according to one or more contemplated embodiments.

Moreover, the features of FIG. 2A and the features of FIG. 2B are not intended to be mutually exclusive. Rather, in some embodiments, the features of FIGS. 2A-2B can be combined to particular advantage. For example, one or more of the segments 252 of FIG. 2B can be formed of a material 200 that has a resistivity that varies along the radial direction 116. Other combinations and variations should be readily apparent to one of ordinary skill in the art.

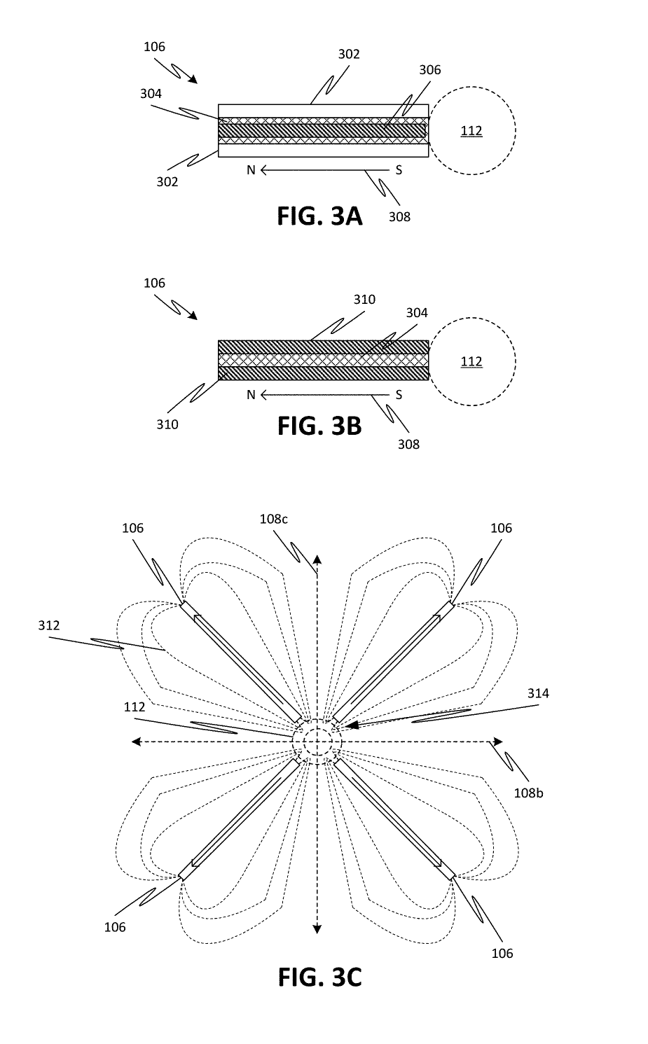

As noted above, embodiments of the CE-IEC device can provide a magnetic field to help confine electrons to the core region 112. Since only enough electrons are needed to neutralize the traveling ions, the magnetic field requirement is relatively low and can be satisfied using permanent magnets (e.g., formed of a rare-earth material, such as neodymium, or other permanent magnetic material). For example, radially polarized permanent magnets may be incorporated into sidewalls 106 with same poles (either north or south) facing the core 112. The resulting magnetic field has field lines 312 extending through the channels formed by the sidewalls 106, e.g., substantially following the particle paths 108a-108c, as shown in FIG. 3C. At the core 112, the permanent magnets form a cusped magnetic field 314, which acts as a magnetic mirror that repels electrons from impacting ends of the sidewalls 106 facing the core 112. Moreover, the cusped magnetic field at the intersection of the particle paths 108a-108c and the outer boundary of the core 112 keep electrons from escaping along the particle paths 108a-108c.

The provision of permanent magnets in the sidewalls 106 allows more material to be used, thereby resulting in a stronger magnetic field, without otherwise compromising transparency to particles exiting the core 112. For example, the permanent magnets 306 can be incorporated into each sidewall 106 between conductive panels 302 thereof, as shown in FIG. 3A. Alternatively or additionally, the permanent magnets 310 can be conductive panels of the sidewall 106 itself and used to provide both the magnetic and potential profiles, as shown in FIG. 3B. Depending on the desired profile of the magnetic field, the amount of magnetic material may be uniform or vary along the radial direction, and/or can be the same or different between different sidewalls at the same radius. The magnets can optionally be separated from the conductive panels 302 or other magnets 310 by an insulating spacer 304.

Each magnet would have a polar orientation 308 extending radially (i.e., with one pole adjacent to the core 112, and the opposite pole spaced at a radially outer location). Although a particular polar orientation is illustrated in FIGS. 3A-3B, embodiments of the disclosed subject matter are not limited thereto. Indeed, a polar orientation for each magnet opposite that illustrated may be adopted with similar effect.

Although FIGS. 3A-3C illustrate a configuration with the permanent magnets extending along the length of the sidewalls, embodiments of the disclosed subject matter are not limited thereto. Indeed, in some cases, electrons that approach the cusped magnetic field with a sufficiently low pitch angle (i.e., more parallel to the field lines) may not be turned around before the point of maximum field strength. As a result, some amount of electron leakage from the core may occur. Electrons that escape the core would be accelerated by the focusing region 110 to leave the CE-IEC device, which loss would be undesirable.

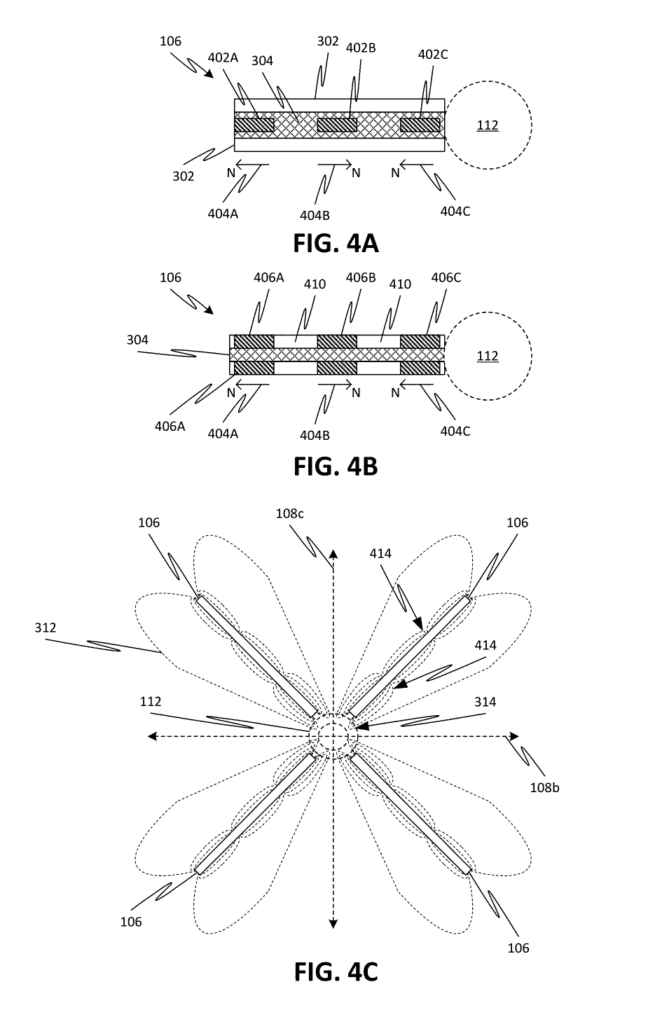

To avoid such electron losses, additional cusps 414 can be provided within the focusing region 106 along the particle paths 108a-108c, as shown in FIG. 4C. Electrons escaping the core 112 that encounter the cusp 414 can be guided to the sidewall 106 by the magnetic field 312, and thus absorbed at a potential that is closer to that of the core 112. The cusps 414 may be repeated along the radial direction—due to randomization of electron velocities between null regions of the magnetic fields, an electron that makes it through one cusp 414 may not necessarily make it through a subsequent cusp 414. As a result, power loss by escaping electrons can be reduced. In addition, these magnetic field lines can help ions from spreading too far in the azimuthal direction and potentially impacting the sidewalls 106. Moreover, the periodic magnetic field (experienced by the ion bunches as they recirculate along the particle paths 108a-108c) can help to compress the ion bunches in the azimuthal direction.

Such cusped magnetic fields can be generated by incorporating multiple separate magnets in the sidewalls along the radial direction. For example, radially polarized permanent magnets 402A-402C may be incorporated into sidewalls 106, with polar orientations 404A-404C alternating along the radial direction, as shown in FIG. 4A. Alternatively or additionally, the permanent magnets 406A-406C can be conductive panels of the sidewall 106 itself and used to provide both the magnetic and potential profiles, as shown in FIG. 4B. The magnets can optionally be separated from the conductive panels 302 or other magnets 406A by insulating spacers 304 and/or 410. The innermost magnet 402C of the sidewalls 106 can have the same pole facing the core.

Each magnet would have a polar orientation 404A-404C extending radially (i.e., with one pole closer to the core 112, and the opposite pole spaced at a radially outer location). The resulting magnetic field lines 312 extend through the channels formed by the sidewalls, but with cusped regions 414 directed toward the sidewalls. Although a particular polar orientation is illustrated in FIGS. 4A-4B, embodiments of the disclosed subject matter are not limited thereto. Indeed, a polar orientation for each magnet opposite that illustrated may be adopted with similar effect. Although an alternating polar orientation is illustrated in FIGS. 4A-4B, in certain embodiments, the polar orientation of each magnet 402A-402C of the sidewall 106 can be the same (i.e., non-alternating, with a north pole facing the south pole of the adjacent magnet).

Moreover, the features of FIG. 3A-4C are not intended to be mutually exclusive. Rather, in some embodiments, the features of FIGS. 3A, 3B, 4A, and/or 4B can be combined to particular advantage. For example, one or more sidewalls can be formed of a permanent magnet, while other sidewalls can be formed of permanent magnet segments. Other combinations and variations should be readily apparent to one of ordinary skill in the art.

Although the magnetic field configurations of FIGS. 3A-4C have been separately illustrated from the electric field configurations of FIGS. 2A-2B, embodiments of the disclosed subject matter can employ both techniques, for example, to cooperatively contain electrons within the core. For example, the electrons can be prevented from hitting ends of the sidewalls 106 facing the core 112 by the cusped magnetic field 314 provided by the permanent magnets, despite the field generated by inner anode region 128 of sidewalls 106. Meanwhile, electrons that are able to escape the core and enter the particle paths 108a-108c between sidewalls 106 can be turned back by the electric field generated by the cathode region 124 of the sidewalls 106.

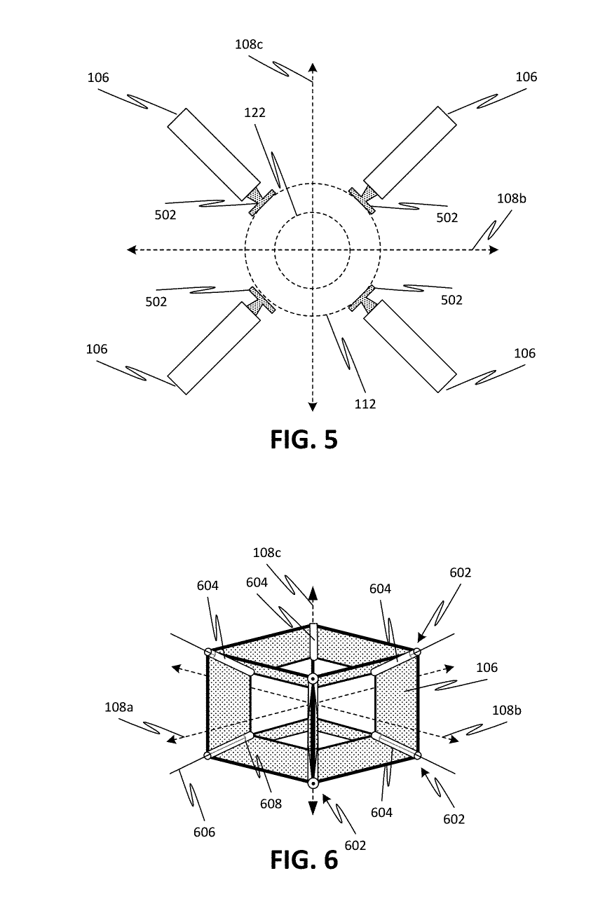

Despite the provision of a cusped magnetic field, high-angle scattered ions and/or fusion products can impact the edges of the sidewalls 106 facing the core 112. These impacts can cause undesirable heating of the sidewall 106 and its components (e.g., permanent magnets, embedded electrodes, sensors, etc.). Heating of the permanent magnets is especially undesirable as it may lead to de-magnetization. To avoid damaging the sidewalls 106, protective standoffs 502 (i.e., shields) can be provided at the innermost edge of the sidewalls 106, as shown in FIG. 5, to absorb impacts from the ions and fusion products. Since energetic particles impacting the standoff 502 will deposit both energy and momentum, which will cause both heating and sputtering, the standoffs 502 can be formed of a material having a very high melting point (e.g., greater than 2000K) and be resistant to sputtering. For example, the standoff 502 can be formed of tungsten or carbon.

Instead of forming the standoff 502 from the heat-resistant material, the standoff 502 can be coated with a layer of the heat-resistant material. For example, the heat-resistant material could be flowed through a pipe extending along sidewall 106, for example, via expanded channel 604 of FIG. 6 (or temporarily along the particle paths 108a-108c between the sidewalls 106), to coat the radially inner surface of the standoff 502. This material could be allowed to sputter away as a result of particle impacts, which can provide a mechanism for heat removal in addition to protecting the standoff 502 and the sidewalls 106 from erosion.

Any heat absorbed by the standoff 502 may be passively radiated away or actively cooled by a separate mechanism (e.g., a heat transfer fluid circulating through the standoff 502). The standoff 502 can also be formed of sufficient thickness (or coated with sufficient thickness) such that any sputtering that does occur would still allow for a sufficient lifetime of operation before failure. For example, if sputtering resulted in loss of approximately 0.013 monolayers/second, a standoff 502 having a 1 cm thick layer of carbon could have a lifetime of several years.

In embodiments, transparency of the CE-IEC device can be maintained by taking advantage of otherwise unused real estate of the sidewall structures for various functions, such as, but not limited to, electrical connections for voltage or signals, supporting permanent magnets, feeding fuel (e.g., ions) for fusion, and coating standoffs. For example, one or more of the vertices 602 between adjacent sidewalls 106 can be expanded into channel 604 to accommodate an electrical feed line 606, as shown in FIG. 6. The electrical feed line 606 can be coupled to one or more sidewalls 106 at an internal attachment point 608 to provide a bias to the sidewall 106 to generate the radially varying potential field. Outside of the coupling 608, the feed line 606 within the channel 604 can be electrically isolated so as to avoid impacting the potential profile.

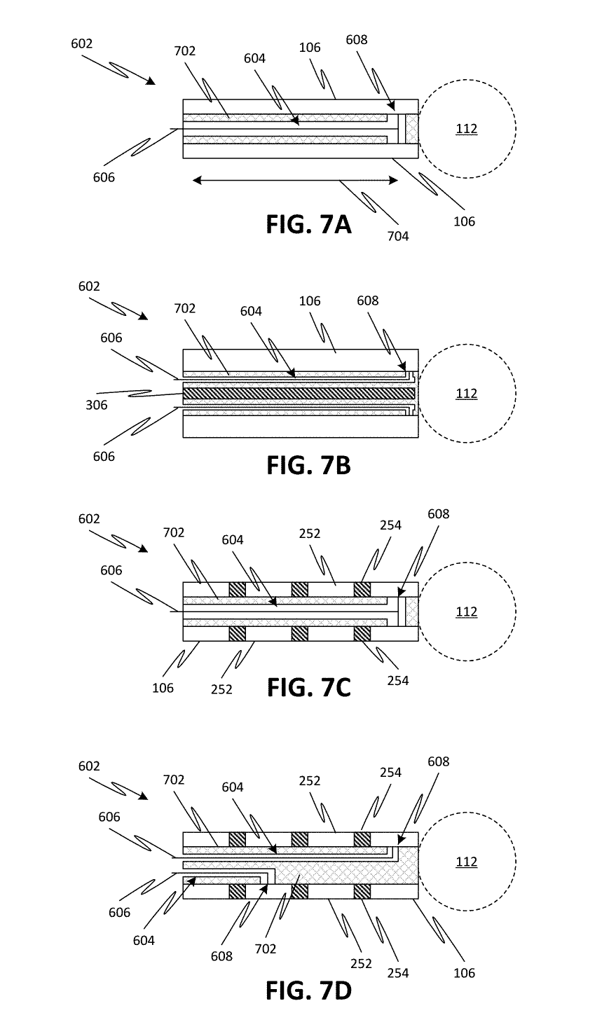

The channel 604 may accommodate a single electrical feed line 606, for example, to set a potential at a single radial location. For example, FIG. 7A illustrates a configuration of the vertex channel 604 where a single feed line 606 is coupled to adjacent sidewalls 106 at internal attachment points 608. The feed line 606 is insulated along its length outside of attachment point 608 by insulating wall 702. Such a configuration may be employed, for example, when the sidewall is formed of a material that has a resistivity that varies along 704, i.e., the radial direction, although the configuration can also be applied to a sidewall formed of multiple segments 252, as illustrated in FIG. 7C

Alternatively or additionally, the channel 604 may accommodate multiple electric feed lines 606 to set potentials on different sidewalls, while also having a permanent magnet therein. For example, FIG. 7B illustrates a configuration of the vertex channel 604 where multiple feed lines 606 are disposed around an embedded permanent magnet 306 and separated therefrom by insulating material 702. Each feed line 606 can be coupled to a respective sidewall 106 at a corresponding attachment point 608. Again, the feed line 606 may be insulated along its entire length outside of attachment point 608 by insulating material 702.

Alternatively or additionally, the channel 604 may accommodate multiple electric feed lines 606, for example, to set potentials at more than one radial location. For example, FIG. 7D illustrates a configuration of the vertex channel 604 where multiple feed lines 606 extend to different radial depths and are separated from each other and the sidewalls 106 by insulating material 702.

The features of FIGS. 7A-7D are not intended to be mutually exclusive. Rather, in some embodiments, the features of FIGS. 7A-7D can be combined to particular advantage. For example, some vertex channels 604 may have the configuration of FIG. 7C, while other feed channels may have the configuration of FIG. 7D, especially if the number of available vertices may be otherwise limited. Other combinations and variations should be readily apparent to one of ordinary skill in the art.

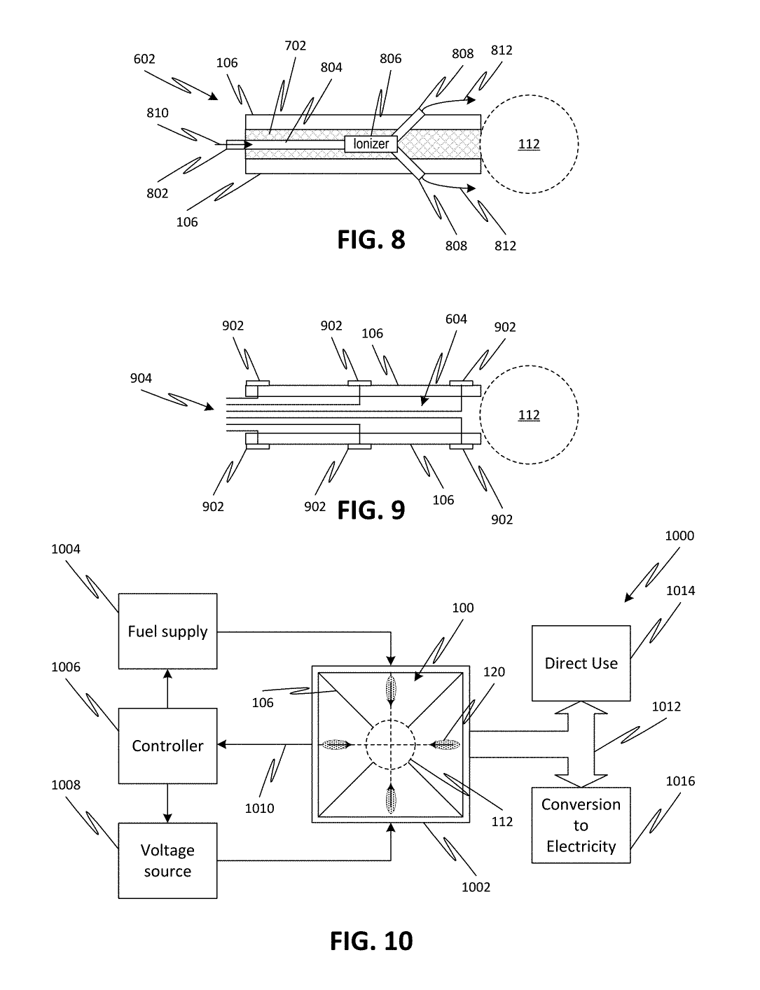

The vertex channels 604 could also be used to provide fuel to the CE-IEC device for fusion. For example, protons and boron ions can be generated at appropriate radial locations within a particle path so that the relative energy matches the fusion cross-section resonance, and so that the center mass of the reaction is stationary at the device core (i.e., zero net momentum). To achieve this, neutral atoms can be fed into the device to an appropriate radius prior to ionization. If the feed tubes were placed within the particle paths, they would be subject to fusion product bombardment. To avoid such bombardment, the feed tubes 804 are placed between the sidewalls 106, for example, at the vertices 602 between adjacent sidewalls, for example, as shown in FIG. 8. Non-ionized fuel 810 is introduced at inlet 802 of the fuel feed tube 804, where it is conveyed down to an appropriate radius before being ionized by ionizer 806. The resulting ions can then be injected transversely to the particle path via outlets 808 extending through sidewalls 106. The injected ions 812 mix with existing ions and join the ion bunches traveling along the particle paths. Injection slightly above the required energy level can allow for energy losses and for the ion to approach the resonance peak from above.

The vertex channels 604 could also be used to convey signals to/from locations within the sidewalls 106, for example, to convey sensor signals. As discussed above, the potential may be dynamically controlled to compact ion bunches as they travel along the particle paths. In some embodiments, the potential may be controlled without feedback (i.e., open loop), for example, by establishing a time-varying profile and allowing the traveling ion bunches to synchronize to the profile.

Alternatively, one or more sensors 902, as illustrated in FIG. 9, may be disposed along the sidewalls 106 to monitor the ion bunches as they travel along the particle path. The profile can then be dynamically adjusted in real time to compact the ion bunches or for any other purpose (e.g., to transfer energy to the ion bunch). The sensors 902 may be disposed on a surface of the sidewalls 106 (as shown), within the sidewalls 106, or behind the sidewalls 106 (i.e., within channel 604). Other sensor types and configurations are also possible according to one or more contemplated embodiments, for example, to monitor variable indicative of operation of CE-IEC device, such as temperature, electron population in core, standoff thickness, etc. Signals from the sensors 902 can be communicated via signal wires 904 for subsequent use, for example, by controller 1006. Although shown as extending along vertex channel 604, it is also possible for the signal wires 904 to be disposed between adjacent panels of sidewalls 106 away from the vertex 602.

Referring to FIG. 10, an overview of a system 1000 including a CE-IEC device 100 is shown. When the CE-IEC device 100 is used in a space environment, the CE-IEC device 100 may be housed in an enclosure 1002 that may be open to the environment (i.e., vacuum). Otherwise, the enclosure 1002 of the CE-IEC device 100 is a chamber that maintains a vacuum environment.

The CE-IEC device 100 can be coupled to a controller 1006 that controls operation thereof. Such control by the controller 1006 can include providing a static potential and/or a dynamic potential (e.g., to compact ion bunches) to the sidewalls 106 using voltage source 1008. Although shown as a single component, voltage source 1008 can include multiple voltage sources and/or be capable of generating multiple independent voltages (for example, as needed for the multiple sidewall segments of FIG. 2B). The controller 1006 can also control fuel supply 1004 to supply non-ionized fuels to the CE-IEC device 100, for example, to be ionized in situ as in FIG. 8. The control by the controller 1006 may be responsive to feedback from one or more sensor signals 1010, for example, the sensors of FIG. 9.

The fusion products 1012 can be directed from the focusing region 110 of the CE-IEC device 100 for subsequent use, for example, directly utilized 1014 (e.g., propulsion of a spacecraft) and/or converted for use 1016 (e.g., converted to electricity using electrostatic deceleration and/or dynamically oscillating potentials). In the latter utility, the kinetic energy of the fusion products can be directly converted into electrical energy. Alternatively or additionally, the fusion products can be used to charge a conducting plate, which resulting charge can be used to drive a high impedance load.

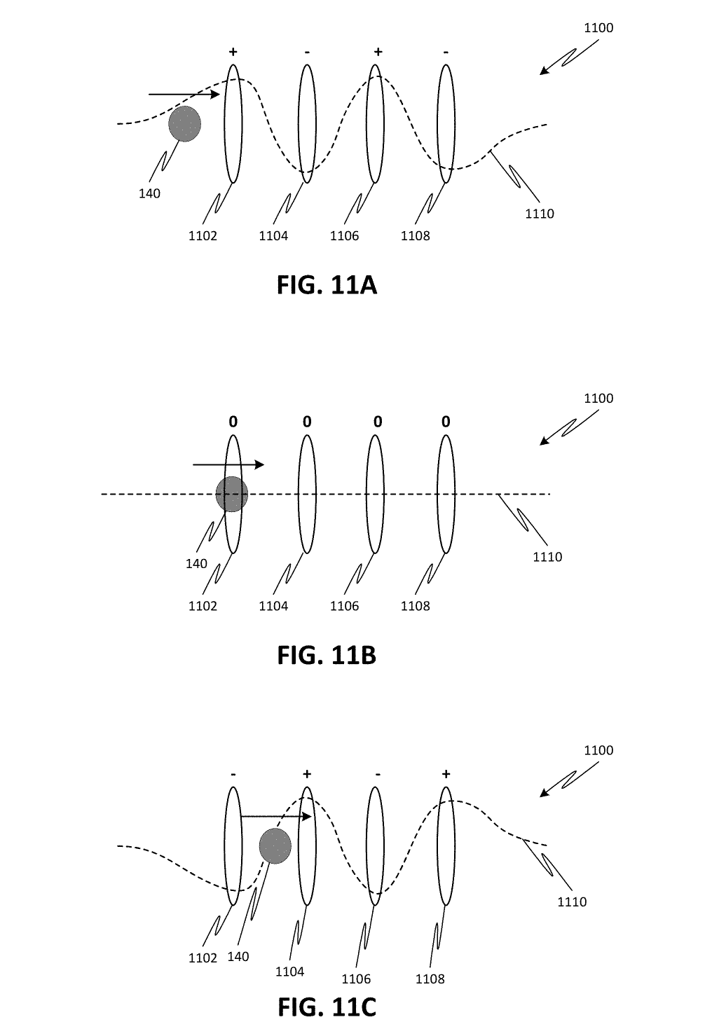

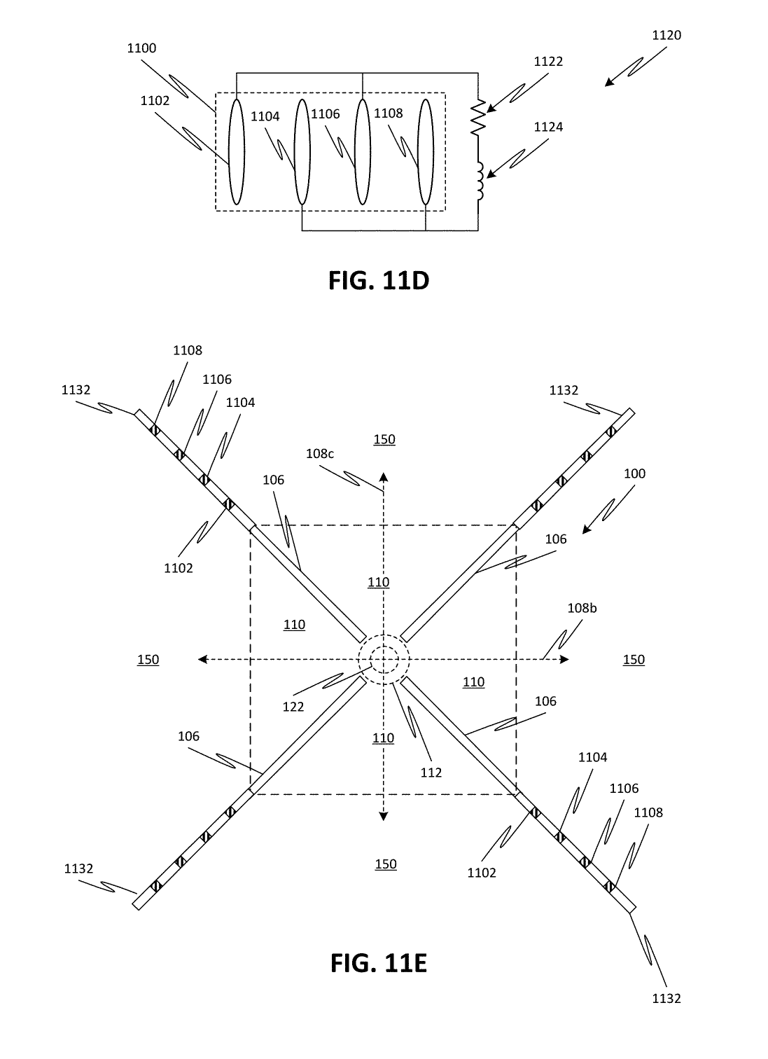

For example, FIGS. 11A-11C show aspects of a 1-D version of a standing wave direct energy conversion (SW-DEC) process 1100 for converting the fusion products to electricity. The fusion products 140 pass along the particle paths 108a-108c and are energetic enough to escape the focusing region 110 and reach the power conversion region 150. In the power conversion region 150, a plurality of ring-shaped electrodes 1102-1108 are sequentially disposed along a path collinear with one of the particle paths 108a-108c. Alternating ring electrodes are coupled together, such that odd numbered electrodes are in-phase with each other, and the even numbered electrode are 180° out of phase with the odd numbered electrodes.

As the fusion products 140 approach the first electrode 1102 in FIG. 11A, the first and third electrodes 1102, 1106 are rising toward their peak potential, while the second and fourth electrodes 1104, 1108 are falling toward their minimum potential. The potential 1110 along the axis seen by the fusion products 140 has a positive gradient, which decelerates the fusion products. As the fusion products 140 pass through the first electrode 1102 in FIG. 11B, the potential is approximately zero as the potentials reverse. Once past the first electrode 1102, the first and third electrodes 1102, 1106 are falling toward their minimum potential, while the second and fourth electrodes 1104, 1108 are rising toward their peak potential, as shown in FIG. 11C. Thus, the fusion products continue to experience a positive gradient that further causes deceleration. The process of FIGS. 11A-11C continues for each subsequent ring, extracting additional energy with the passing of each subsequent electrode. Although illustrated as equally spaced in FIGS. 11A-11C, it is also possible to place consecutive rings closer together to compensate for reduced velocity of the fusions products.

For example, the electrodes 1102-1108 can form the capacitive element of a tuned resistor-inductor-capacitor (RLC) circuit 1120, as shown in FIG. 11D. The first and third electrodes 1102, 1106 can be connected together as one plate of the capacitor while the second and fourth electrodes 1104, 1108 can be connected together as the opposing plate of the capacitor. A resistor 1122 and an inductor 1124 can be connected in series between the plates of the capacitor. As the fusion products 140 lose kinetic energy passing through electrodes 1102-1108, a corresponding amount of energy is pumped into the circuit 1120, thereby increasing its oscillation amplitude. The resistive element 1122 of the circuit 1120 can be a load, which could be operating equipment or an energy storage device.

The description of FIGS. 11A-11D is for a simplified 1-D SW-DEC configuration. An SW-DEC configuration applied to practical embodiments of the CE-IEC device would necessarily be more complex, with ring or wire mesh electrodes provided at each end of particle paths 108a-108c to capture energy of fusion products emanating therefrom. For example, to implement the SW-DEC configuration in the power conversion region 150 of the CE-IEC, each electrode ring can be at a separate radius from the central core. However, instead of individual rings, each radial layer would be thin walled 3-D honeycomb structure, similar to the construction of the sidewalls forming the particle path channels. Such a configuration would maintain the high transparency of the CE-IEC, while allowing the fusion products to strongly couple to the electrodes. At the outermost radius of the SW-DEC, the fusion products can be driven into an electrode (not shown) where they would be neutralized and allowed to pass out into space. The charging of this electrode due to electron loss could also potentially be used to convert any remaining percentage of the kinetic energy of the fusion products into electricity.

An exemplary configuration of a 3-D SW-DEC is illustrated in the cross-sectional view of FIG. 11E, where ring electrodes 1102-1108 are disposed along common radial lines in the power conversion region 150. The ring electrodes 1102-1108 may be supported in position with respect to each other by supports 1132, which may also connect the ring electrodes 1102-1108 to the sidewalls 106 of the CE-IEC device 100. The supports 1132 may also provide electrical connectivity between the various ring electrodes and/or other components. Other configurations are also possible according to one or more contemplated embodiments. For example, although four electrodes (rings in FIGS. 11A-11D, cubes in FIG. 11E) have been illustrated, fewer or greater number of electrodes may be provided for the SW-DEC system.

Although a cubic configuration for the CE-IEC device 100 is illustrated in FIGS. 1-11, this is merely the simplest configuration for explanation of the features of the present disclosure and embodiments are not limited to such geometries. For example, the innermost edge 104 and/or the outermost edge 102 can lie on a sphere, such that each half of the particle path outside the core region 112 takes the form of a truncated cone (defining a circular face perpendicular to the radial direction).

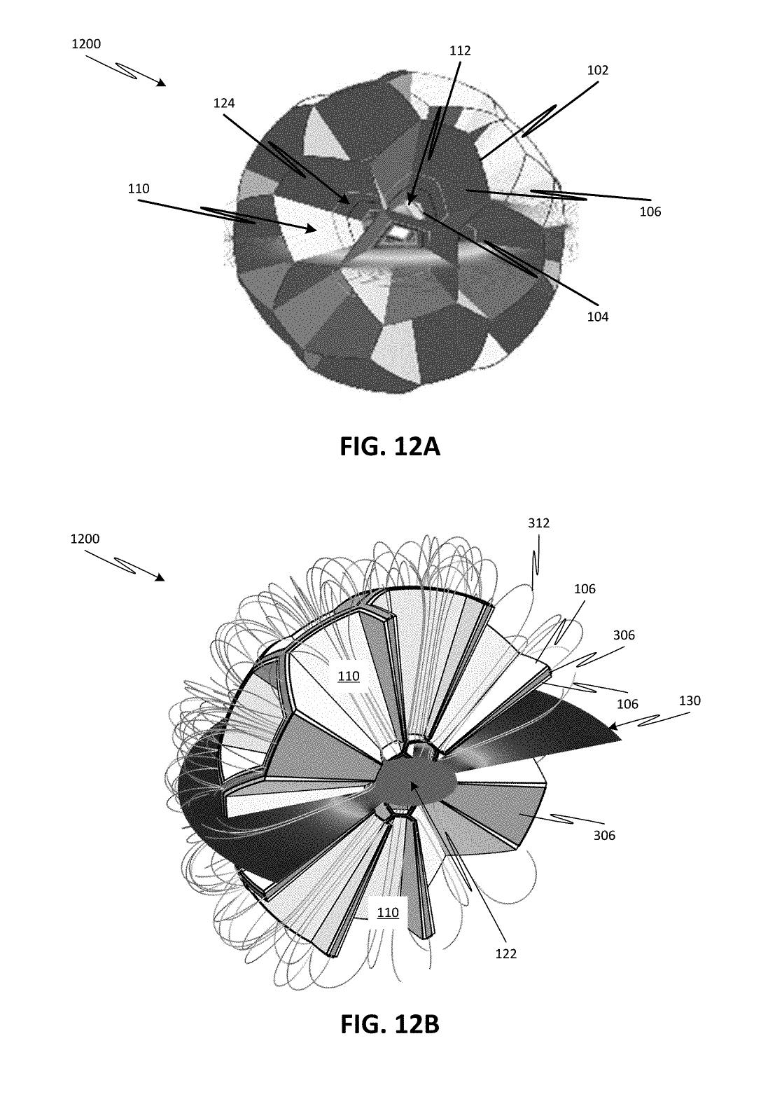

Indeed, practical embodiments of the disclosed subject matter may employ other configurations with different particle path geometries and/or number of particle paths. To this end, the sidewall structure can be formed by radial extrusion of the edges of any polyhedron, so long as the faces of the polyhedron come in diametrically opposed pairs in order to create the aligned particle paths on opposite sides of the core. For example, the number of particle pathways can be increased and the geometry of the innermost edge 104 and/or outermost edge 102 can be more complex, such as a truncated icosahedron (e.g., soccer ball geometry), as described in further detail below with respect to FIGS. 12A-12B. Accordingly, geometries other than those specifically illustrated are also possible according to one or more contemplated embodiments.

An entire family of highly symmetric CE options is provided by the geometry of fullerenes—carbon molecules that form closed polyhedral cages. Fullerenes are labeled as C_{N}, where N is the number of carbon atoms in the molecule. Of particular interest are those of icosahedral (−Iₕ) symmetry, such as C₂₀, C₆₀, C₈₀, C₂₄₀, etc., where a necessary condition is that N must be a multiple of 20. For each of these, 12 faces are always pentagons and the rest are always hexagons. A regular truncated icosahedron (RTI) has edges of equal length, but the hexagonal faces have an area that is about 60% larger than the pentagons. This is the geometry of the C₆₀ molecule (and the soccer ball). However, the truncation of the icosahedron can be done in such a way that instead of ending up with the edges all the same length, one can achieve a geometry where the two types of faces can be inscribed by circles having substantially the same area. This makes the resulting particle paths more equivalent. FIG. 12A shows an exemplary CE-IEC device 1200 employing such geometry, which is referred to as the special irregular truncated icosahedron (SITI). FIG. 12B shows a cutaway version of the CE-IEC device 1200 and illustrates exemplary magnetic field lines and an exemplary electric potential as well as other hidden components (e.g., internal permanent magnets).

Embodiments of the CE-IEC device can employ various nuclear fusion fuels. For example, the CE-IEC device can employ the deuterium-tritium (D-T) reaction or the deuterium-deuterium (D-D) reaction. For single species fuel, such as D-D, only two diametrically opposed ion bunches 120 will be present along each particle path at any given time, one bunch on each side of the core. While the burning of D-T has the highest cross-section, it may suffer from the production of highly energetic neutrons, which can be absorbed into the nuclei of other materials and create unstable radioactive isotopes. In addition, scattering of these neutrons can dislocate atoms from their lattices resulting in structural degradation over time.

In another example, the CE-IEC device uses an aneutronic fuel such as p-¹¹B, which is the fusion of a hydrogen atom with the most common isotope of boron. The result of the fusion process is three helium nuclei (alpha particles) with a total energy of about 8.7 MeV. For two-species fuel such as p-¹¹B, four diametrically opposed bunches 120—one pair for each of the two species—will be present along each particle path at any given time, two bunches on each side of the core, separated radially.

Although features of the various figures have been separately illustrated, embodiments of the disclosed subject matter can combine one or more of the separately illustrated features. For example, embodiments can include the sidewall geometry features of FIGS. 1A-1C or 12A-12B, the continuous electrode features of FIGS. 2A-2B, the permanent magnet features of FIGS. 3A-4C, the protective standoff features of FIG. 5, the electric feed line features of FIGS. 6-7D, the fuel feed features of FIG. 8, the sensor features of FIG. 9, the control features of FIG. 10, and/or the power generation features of FIGS. 11A-11C. Accordingly, embodiments of the disclosed subject matter are not limited to the configurations specifically illustrated.

Moreover, although the above description has focused on the use of the CE-IEC device for nuclear fusion, embodiments of the disclosed subject matter are not necessarily limited thereto. Indeed, aspects of the disclosed subject matter may be employed in other applications that have traveling ions.

It will be appreciated that the aspects of the disclosed subject matter can be implemented, fully or partially, in hardware, hardware programmed by software, software instruction stored on a computer readable medium (e.g., a nontransitory computer readable medium) or a combination of the above.

For example, components of the disclosed subject matter, including components such as a controller, processor, or any other feature, can include, but are not limited to, a personal computer or workstation or other such computing system that includes a processor, microprocessor, microcontroller device, or is composed of control logic including integrated circuits such as, for example, an application specific integrated circuit (ASIC).

Features discussed herein can be performed on a single or distributed processor (single and/or multi-core), by components distributed across multiple computers or systems, or by components co-located in a single processor or system. For example, aspects of the disclosed subject matter can be implemented via a programmed general purpose computer, an integrated circuit device (e.g., ASIC), a digital signal processor (DSP), an electronic device programmed with microcode (e.g., a microprocessor or microcontroller), a hard-wired electronic or logic circuit, a programmable logic circuit (e.g., programmable logic device (PLD), programmable logic array (PLA), field-programmable gate array (FPGA), programmable array logic (PAL)), software stored on a computer-readable medium or signal, an optical computing device, a networked system of electronic and/or optical devices, a special purpose computing device, a semiconductor or superconductor chip, a quantum computing chip or device, a software module or object stored on a computer-readable medium or signal.

When implemented in software, functions may be stored on or transmitted over as one or more instructions or code on a computer-readable medium. The steps of a method or algorithm disclosed herein may be embodied in a processor-executable software module, which may reside on a computer-readable medium. Instructions can be compiled from source code instructions provided in accordance with a programming language. The sequence of programmed instructions and data associated therewith can be stored in a computer-readable medium (e.g., a nontransitory computer readable medium), such as a computer memory or storage device, which can be any suitable memory apparatus, such as, but not limited to quantum-based memory, read-only memory (ROM), programmable read-only memory (PROM), electrically erasable programmable read-only memory (EEPROM), random-access memory (RAM), flash memory, disk drive, etc.

As used herein, computer-readable media includes both computer storage media and communication media, including any medium that facilitates transfer of a computer program from one place to another. Thus, a storage media may be any available media that may be accessed by a computer. By way of example, and not limitation, such computer-readable media may comprise RAM, ROM, EEPROM, CD-ROM or other optical disk storage, magnetic disk storage or other magnetic storage devices, quantum-based storage, or any other medium that may be used to carry or store desired program code in the form of instructions or data structures and that may be accessed by a computer.

Also, any connection is properly termed a computer-readable medium. For example, if the software is transmitted from a website, server, or other remote source using a transmission medium (e.g., coaxial cable, fiber optic cable, twisted pair, digital subscriber line (DSL), or wireless technologies such as infrared, radio, and microwave), then the transmission medium is included in the definition of computer-readable medium. Moreover, the operations of a method or algorithm may reside as one of (or any combination of) or a set of codes and/or instructions on a machine readable medium and/or computer-readable medium, which may be incorporated into a computer program product.

One of ordinary skill in the art will readily appreciate that the above description is not exhaustive, and that aspects of the disclosed subject matter may be implemented other than as specifically disclosed above. Indeed, embodiments of the disclosed subject matter can be implemented in hardware and/or software using any known or later developed systems, structures, devices, and/or software by those of ordinary skill in the applicable art from the functional description provided herein.

In this application, unless specifically stated otherwise, the use of the singular includes the plural, and the separate use of “or” and “and” includes the other, i.e., “and/or.” Furthermore, use of the terms “including” or “having,” as well as other forms such as “includes,” “included,” “has,” or “had,” are intended to have the same effect as “comprising” and thus should not be understood as limiting.

Any range described herein will be understood to include the endpoints and all values between the endpoints. Whenever “substantially,” “approximately,” “essentially,” “near,” or similar language is used in combination with a specific value, variations up to and including 10% of that value are intended, unless explicitly stated otherwise.

It is thus apparent that there is provided in accordance with the present disclosure, systems, methods, and devices for inertial electrostatic confinement. Many alternatives, modifications, and variations are enabled by the present disclosure. While specific examples have been shown and described in detail to illustrate the application of the principles of the present invention, it will be understood that the invention may be embodied otherwise without departing from such principles. For example, disclosed features may be combined, rearranged, omitted, etc. to produce additional embodiments, while certain disclosed features may sometimes be used to advantage without a corresponding use of other features. Accordingly, Applicant intends to embrace all such alternatives, modifications, equivalents, and variations that are within the spirit and scope of the present invention.

1. A device comprising:
a central core region;
particle paths radially extending from the central core region, each particle path having a corresponding particle path aligned therewith on an opposite side of the central core region;
sidewalls that extend in a radial direction, each particle path being bounded by a corresponding set of the sidewalls;
electrodes coupled to the sidewalls so as to provide an electric field that varies along each particle path from a cathode region proximal to the central core region to an anode region remote from the central core region; and
a control module that controls the electrodes to provide said electric field,
wherein each sidewall provides a continuous surface radially extending from the cathode region to the anode region.

2. The device of claim 1, wherein at least one of the sidewalls is a continuous planar piece of material from the cathode region to the anode region.

3. The device of claim 1, wherein at least one of the sidewalls is composed of segments separated from each other in the radial direction by insulating spacers.

4. The device of claim 3, wherein the electrodes are coupled to respective ones of the segments such that an electric potential of each segment can be independently controlled.

5. The device of claim 1, wherein the controller is configured to control the electrodes to provide an electric field that accelerates ions along each particle path to cause fusion of said ions within the central core region.

6. The device of claim 1, wherein the controller is configured to control the electrodes to provide time varying electric fields that compact ion bunches traveling along the particle paths.

7. The device of claim 6, further comprising:
sensors that monitor the traveling ion bunches and generate signals responsively thereto,
wherein the controller controls the time varying electric fields based on the signals from the sensors.

8. The device of claim 1, wherein electrical connections to the electrodes are routed through insulated conduits at respective intersections of adjacent sidewalls.

9. The device of claim 1,
wherein permanent magnets are disposed between adjacent sidewalls, and
along each radial direction, no more than a single magnet is disposed.

10. The device of claim 9, wherein the permanent magnets are arranged to form a cusped magnetic field adjacent to the central core region, with field lines within each particle path following the radial direction.

11. The device of claim 1,
wherein permanent magnets are disposed between adjacent sidewalls, and
along each radial direction, more than a single magnet is disposed.

12. The device of claim 11, wherein the permanent magnets are arranged to form a cusped magnetic field adjacent to the central core region, with at least some field lines crossing the radial direction within each particle path.

13. The device of claim 1, wherein at least a portion of each sidewall is formed of a permanent magnet.

14. The device of claim 1,
wherein the cathode region is separated from the central core region by a second anode region, and
the second anode region has an electric potential higher than that of the cathode region so as to confine electrons to the central core region while allowing fusion products and ions to escape from the central core region.

15. The device of claim 1,
wherein each sidewall is formed of a material having a resistivity that varies along the radial direction, and
each sidewall acts as an isopotential conductor in an azimuthal direction.

16. The device of claim 1, further comprising shields disposed between the central core region and ends of the sidewalls facing the central core region, the shields being thermally isolated from the sidewalls and protecting the sidewalls from heat and/or impact from particles deviating from the particle paths.

17. The device of claim 1, wherein, when viewed along the respective radial direction, each particle path bounded by the corresponding set of sidewalls has a shape of a polygon with at least three sides.

18. The device of claim 17, wherein areas of said shapes at a same radial distance are substantially equal.

19. The device of claim 1, wherein the central core region is substantially empty except for electrons confined therein, ions traveling therethrough between particle paths, and products resulting from interaction of the traveling ions.

20. The device of claim 1, wherein electrodes are provided at different radial distances for each set of the sidewalls so as to provide different potentials along the corresponding particle path.

21. The device of claim 1, wherein fuel feed paths for injecting ions to the particle paths are provided at respective intersections of adjacent sidewalls.

22. A fusion method comprising:
directing ion bunches along particle paths that radially extend from a central core region, each particle path being bounded by a corresponding set of radially extending sidewalls and having a corresponding particle path aligned therewith on an opposite side of the central core region, each sidewall providing a continuous surface radially extending from a cathode region proximal to the central core region to an anode region remote from the central core region;
generating an electric field that varies along each particle path from the cathode region to the anode region such that the ion bunches are accelerated toward the central core region;
fusing ions from the ion bunches within the central core region; and
allowing fusion products to travel from the central core region to beyond the anode region via said particle paths.

23. The method of claim 22, wherein the generating an electric field comprises varying the electric field with respect to time such that the ion bunches traveling along the particle paths are compacted.

24. The method of claim 23, detecting the ion bunches along the particle paths, wherein the varying of the electric field is responsive to the detecting.

25. The method of claim 22, further comprising confining a population of electrons to the central core region so as to neutralize the ion bunches passing into the central core region.

26. The method of claim 25, wherein the confining comprises generating a cusped magnetic field adjacent to the central core region using a plurality of permanent magnets as said radially extending sidewalls or between adjacent ones of the radially extending sidewalls.

27. The method of claim 26,
wherein more than one permanent magnet is disposed along the radial direction and the poles of the disposed magnets alternate along the corresponding radial direction, and
further comprising using the magnetic fields of the permanent magnets to direct electrons escaping the central core region to the sidewalls.

28. The method of claim 25, wherein the confining comprises controlling the electric field such that a region having a higher potential than that of the cathode region is formed between the central core region and the cathode region along the radial direction.

29. The method of claim 22, further comprising, protecting ends of the sidewalls facing the central core region from heat and/or particle impact using a plurality of shields that are thermally isolated from the sidewalls.

30. The method of claim 22, wherein the central core region is substantially empty except for electrons confined therein, ions traveling therethrough between particle paths, and products resulting from interaction of the traveling ions.

31. The method of claim 22, further comprising, directing the fusion products out of a spacecraft so as to propel the spacecraft.
